(19) United States
(12) Patent Application Publication
(10) Pub. No.: US 2015/0180694 A1
(43) Pub. Date: Jun. 25, 2015

(54) RADIO FREQUENCY CIRCUIT FOR INTRA-BAND AND INTER-BAND CARRIER AGGREGATION

(71) Applicant: Nvidia Corporation, Santa Clara, CA (US)

(72) Inventor: Abdellatif Bellaouar, Richardson, TX (US)

(73) Assignee: Nvidia Corporation, Santa Clara, CA (US)

(21) Appl. No.: 14/134,522

(22) Filed: Dec. 19, 2013

(51) Int. Cl. H04L 27/26

(52) U.S. Cl. CPC H04L 27/2649

(57) ABSTRACT

A radio frequency (RF) circuit for intra-band and inter-band carrier aggregation includes a receive path configured to receive an input signal. The RF circuit includes a low noise amplifier which has multiple separate input stages and multiple separate output stages. Each input stage has multiple separate input paths, wherein each separate input path is configured to be separately activated and connected to one of the output stages. Each separate output stage is configured to be separately activated and connected to a signal mixer that provides signal demodulation of the input signal employing aggregation of carriers corresponding to intra-band or inter-band signals. Methods of operating the RF circuit for intra-band and inter-band carrier aggregation are also provided.

### TECHNICAL FIELD

This application is directed, in general, to communication systems and, more specifically, to a radio frequency circuit for intra-band and inter-band carrier aggregation.

### BACKGROUND

Carrier aggregation is one of the main features of LTE-advanced implementation. Carrier aggregation of two component carriers permits support of wider transmission bandwidths. For example, LTE-advanced applications permit a maximum carrier aggregation of 40 MHz (two 20 MHz bandwidths employing two carriers). Currently, carrier aggregation using two carriers requires two receiver paths, where each is dedicated to a separate carrier. This architecture solves the inter-band implementation issue. However for intra-band applications, it is not efficient since each path is required to duplicate a duplexer, matching network and low noise amplifier for the same band. Moreover, this architecture does not well support multiple bands, since each path requires different demodulating oscillators (e.g., different phase-locked loops). Therefore, an improvement in architecture to support both inter-band and intra-band would prove beneficial to the art.

### SUMMARY

Embodiments of the present disclosure provide a radio frequency (RF) circuit for intra-band and inter-band carrier aggregation. The RF circuit may be used in a receiver front-end which includes duplexers and matching networks. A method of operating the RF circuit for intra-band and inter-band carrier aggregation is also provided.

According to certain disclosed embodiments, the RF circuit includes a receive path configured to receive an input signal. The RF circuit includes a low noise amplifier having multiple separate input stages and multiple separate output stages. Each input stage has multiple separate input paths, wherein each separate input path is configured to be separately activated and connected to one of the output stages. Each separate output stage is configured to be separately activated and connected to a signal mixer that provides signal demodulation of the input signal employing aggregation of carriers.

According to certain disclosed embodiments, only one of the multiple separate input stages is activated for processing an input signal employing aggregation of carriers corresponding to intra-band signals. According to certain disclosed embodiments, multiple separate input stages are activated for processing an input signal employing aggregation of carriers corresponding to inter-band signals. According to certain disclosed embodiments, each of the separate input paths is configured to be activated to process one of the carriers in the input signal employing carrier aggregation.

According to certain disclosed embodiments, a method of operating the RF circuit includes receiving input signals corresponding to an aggregation of carriers corresponding to intra-band or inter-band signals. The method includes providing input signal amplification having multiple separate input stages and multiple separate output stages. Each input stage has multiple separate input paths. Each separate input path is configured to be separately activated and connected to one of the output stages. Each separate output stage is configured to be separately activated and connected to a receive signal mixer that provides signal demodulation of the input signals.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

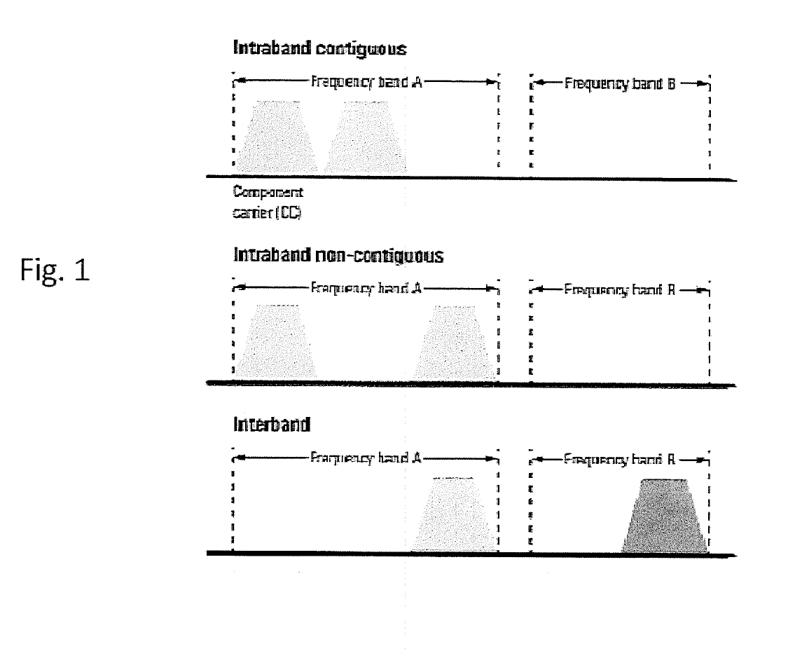

FIG. 1 illustrates various carrier aggregation modes;

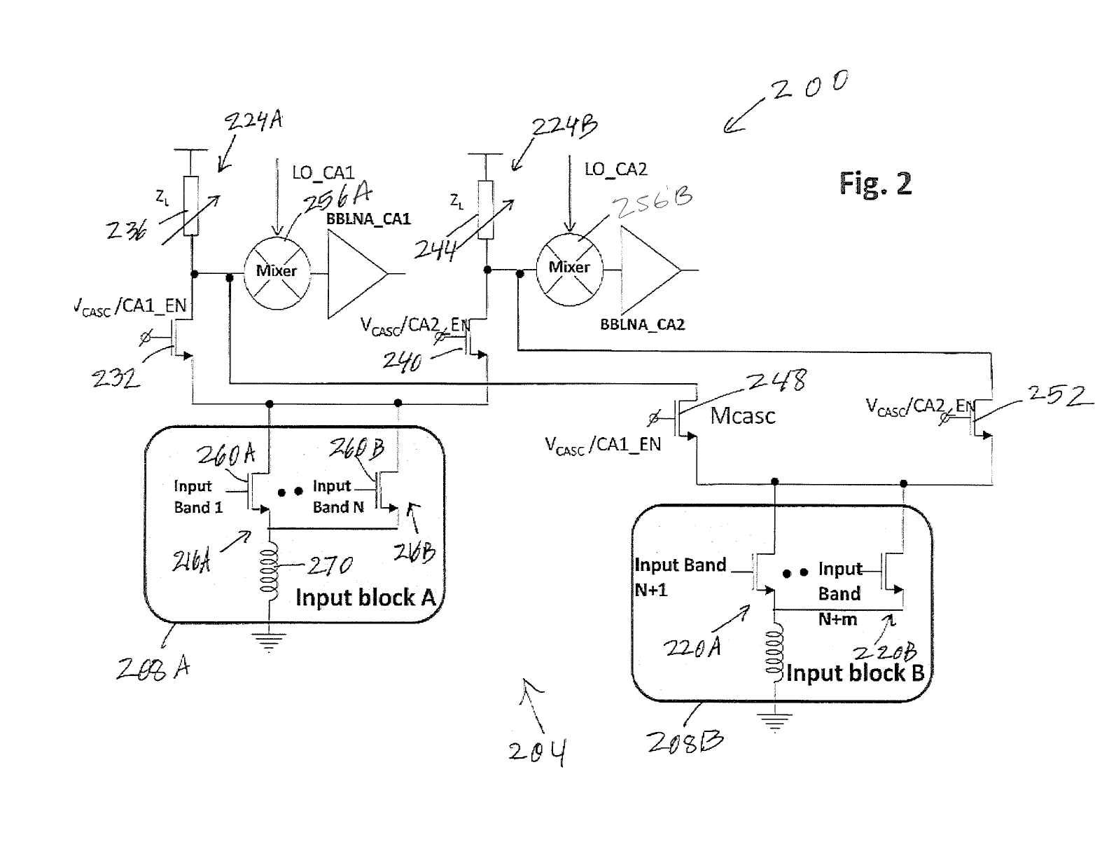

FIG. 2 illustrates an RF circuit according to certain disclosed embodiments;

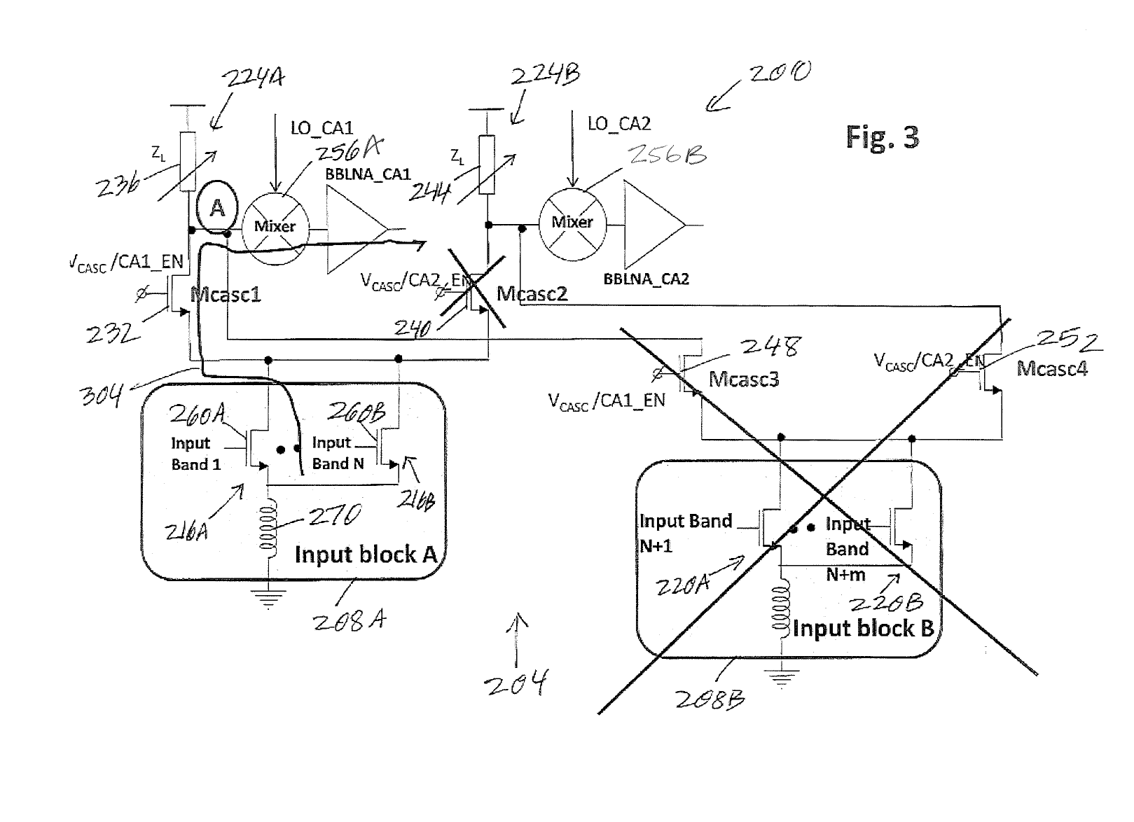

FIG. 3 illustrates an RF circuit employed to receive an RF input signal comprising a single carrier;

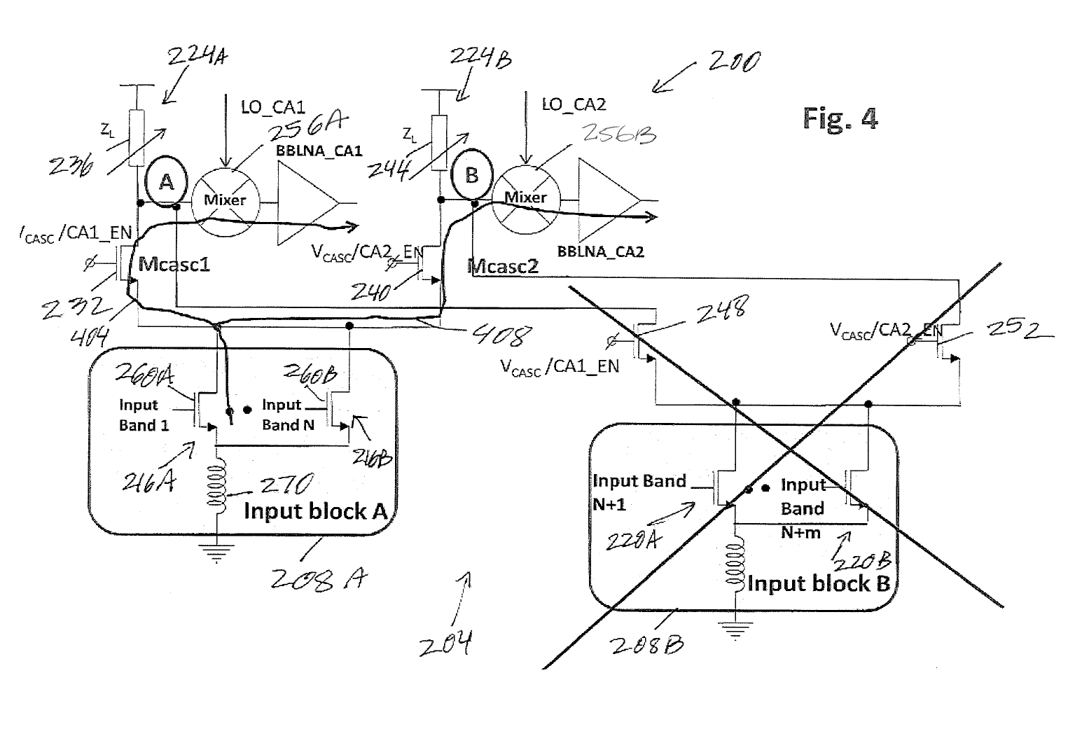

FIG. 4 illustrates an RF circuit employed for intra-band carrier aggregation;

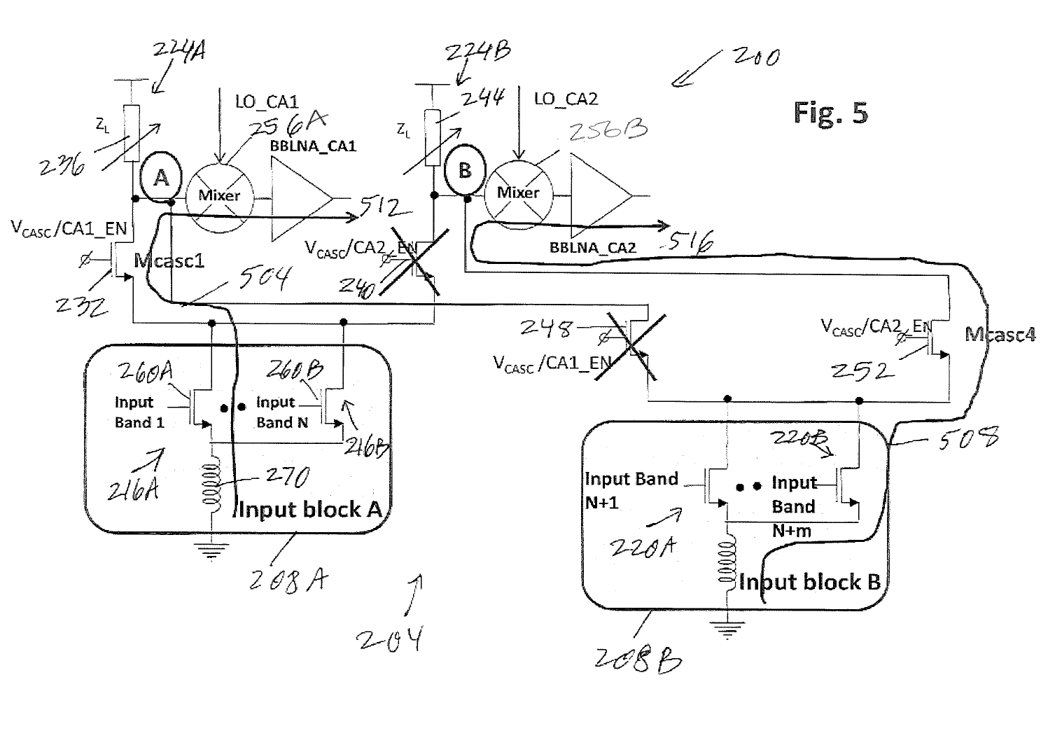

FIG. 5 illustrates an RF circuit employed for inter-band carrier aggregation;

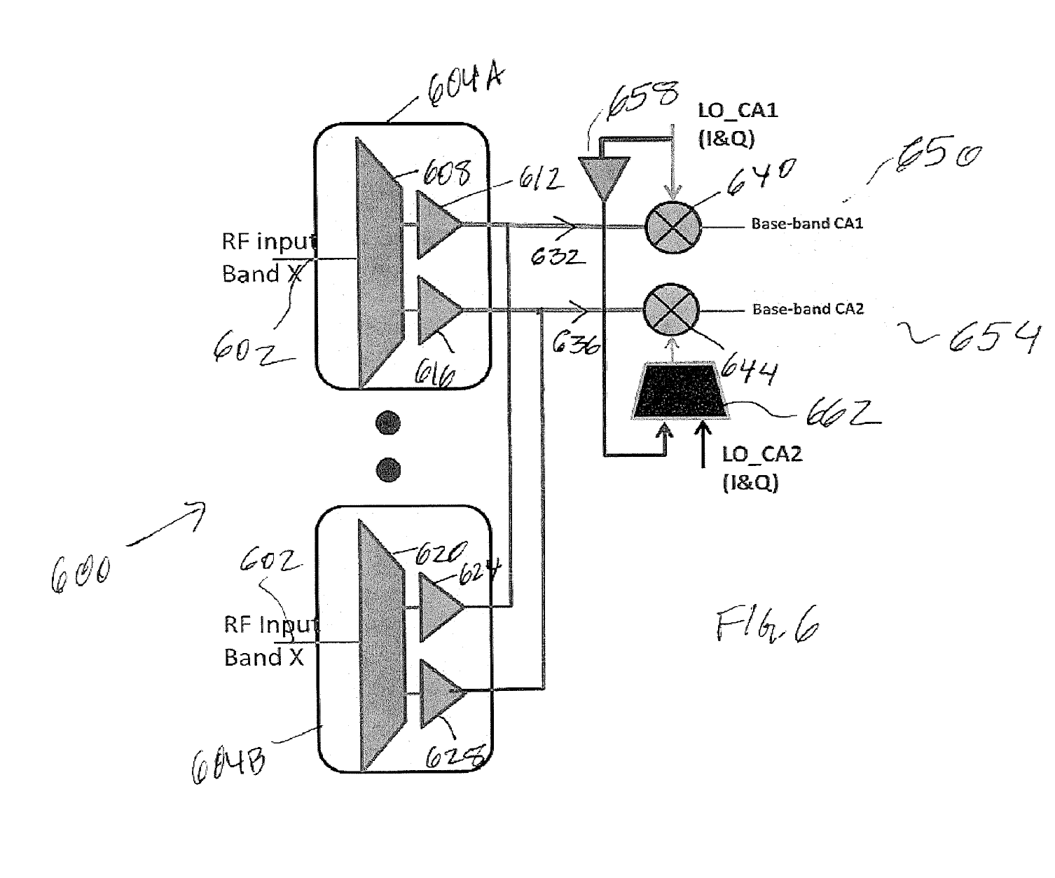

FIG. 6 illustrates a receiver front-end for carrier aggregation in MIMO applications; and

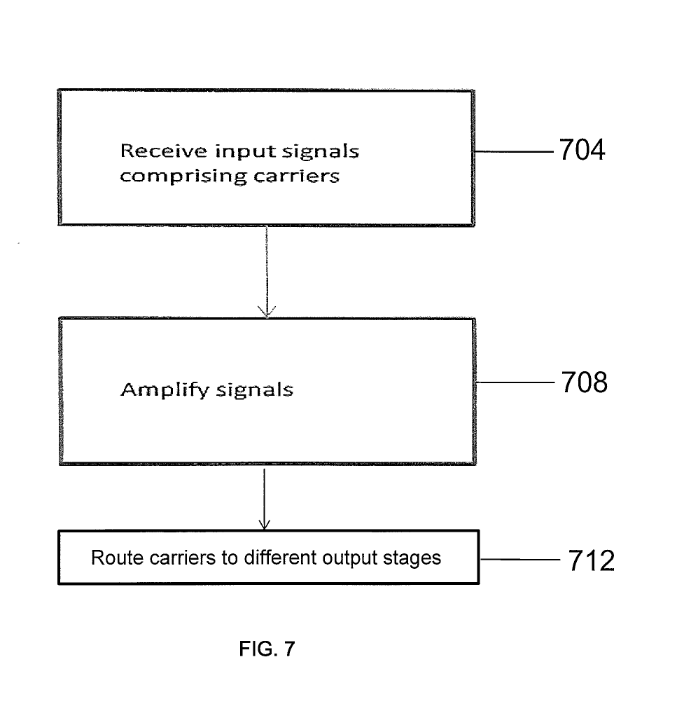

FIG. 7 illustrates a flow diagram of a method according to disclosed embodiments.

### DETAILED DESCRIPTION

Various carrier aggregation modes, generally designated 105, 110 and 115, employing first and second frequency bands A and B as may be employed in a receiver are shown in FIG. 1. Carrier aggregation mode 105 shows two intra-band, contiguous component carriers in frequency band A and no carriers in frequency band B. Carrier aggregation mode 110 shows two intra-band, non-contiguous carriers in frequency band A and no carriers in frequency band B. Carrier aggregation mode 115 shows two inter-band carriers in frequency bands A and B, since inter-band carriers are always located in different frequency bands.

Embodiments of the present disclosure employ a radio frequency (RF) circuit for use in a receiver front-end for aggregation of multi-band, multi-mode carriers. The RF circuit may be for used for carrier aggregation in communication systems featuring conventional single antennas or MIMO antennas.

These embodiments are often illustrated in the following discussions employing only two frequency bands for simplicity of discussion. However, embodiments of the present disclosure are applicable to a multiplicity of frequency bands greater than two. Although single-ended signal applications are shown for simplicity, differential signals as well as IQ modulation applications are also supported by the principles of the present disclosure.

According to certain disclosed embodiments, the RF circuit includes a low noise amplifier (LNA) having multiple separate input stages (also referred to as input blocks) and multiple separate output stages (also referred to as output blocks). Each separate output stage (or output block) is configured to be separately activated (i.e. independently activated) and connected to a signal mixer that provides signal demodulation of an input signal employing one of an aggregation of receiver carriers. For the case of intra-band signals, all of the multiple separate output stages of each low noise amplifier employed are typically activated. For the case of inter-band signals, only one of the multiple separate output stages of each low noise amplifier employed is typically activated.

FIG. 2 illustrates RF circuit 200, constructed according to principles of the present disclosure. RF circuit 200 is configured to receive and process inter-band or intra-band RF signals, wherein intra-band (contiguous or non-contiguous) carriers or inter-band carriers may be employed as was illustrated in the carrier aggregation modes of FIG. 1. RF circuit 200 may accommodate multiple carriers, either inter-band or intra-band, and each of these carriers may employ different bandwidths (e.g., 1.4, 3, 5, 10, 15 and 20 MHz, in one example).

As discussed before, RF circuit 200 may be used in a receiver front-end for aggregation of multi-band, multi-mode carriers. It will be appreciated that a receiver front-end typically includes a duplexer and a matching network for signal conditioning, which are not discussed herein.

RF circuit 200 includes low noise amplifier (LNA) 204 having separate input stages (or input blocks) 208A-N (input stages 208A and 208B are shown in FIG. 2) and separate output stages (or output blocks) 224A-N (output stages 224A and 224B are shown in FIG. 2). Input stage 208A includes multiple separate input paths 216A-N (input paths 216A and 216B are shown in FIG. 2). Likewise, input stage 208B includes multiple separate input paths 220A-N (input paths 220A and 220B are shown in FIG. 2).

RF circuit 200 includes separate output stages 224A-N (output stages 224A and 224B are shown in FIG. 2). Output stage 224A includes NMOS device 232 coupled to load 236. Load 236 may be resistive or inductive. Likewise, output stage 224B includes NMOS device 240 coupled to load 244 which may be resistive or inductive.

RF circuit 200 includes NMOS devices 248 and 252 which are configured to isolate input stages 208A-N from one another and also to connect each input stage to one of mixers 256A-N (mixers 256A and 256B are shown in FIG. 2). According to certain disclosed embodiments, each mixer may be a set of two mixers (e.g., I/Q with LOI and LOQ drives).

NMOS devices 232, 240, 248 and 252 are enabled by applying a bias voltage (e.g., Vcasc) to gate terminals of the NMOS devices, and may be disabled by connecting the gate terminals to ground.

Consider, for example, a scenario wherein an RF input signal is received by receiver RF circuit 200. If the RF input signal comprises two inter-band carriers, an input path (e.g., 216A) of input stage 208A and an input path (e.g., 220A) of input stage 208B may be enabled to receive the RF input signal. If, however, the RF input signal comprises two intra-band carriers, only one input stage (e.g., 208A) may be enabled and all other input stages may be disabled. Thus, the RF input signal may be received at input path 216A and also at input path 216B.

Input path 216A includes NMOS device 260A, and input path 216B includes NMOS device 260B. NMOS devices 260A and 260B may be coupled in a common source or common gate arrangement. By way of example, NMOS devices 260A and 260B may be coupled in a common source arrangement wherein their source terminals are coupled to ground via inductor 270. Input paths 220A and 220B are similarly configured.

As discussed before, output stages 224A and 224B are composed of respective devices 232, 240 and loads 236, 244. The loads are used to vary the gain of the input stages. This architecture helps to reduce any cross-talk among the multiple separate output stages due to the high output impedance of the NMOS devices. The output stages 224A and 224B are activated when the NMOS devices 232 and 240 are placed in a conduction mode by applying respective activation signals to the gate terminals of the NMOS devices.

Output stages 224A and 224B are coupled to respective mixers 256A and 256B. Mixers 256A and 256B include voltage controlled oscillators (VCOs) and dividers (not shown in FIG. 2) for demodulating the input signals to baseband signals. According to certain disclosed embodiments, the mixers may, for example, be I/Q mixers having a 25% duty cycle for the local oscillators. The operation of mixers 256A and 256B are well understood by those skilled in the art.

FIG. 3 illustrates a scenario wherein RF circuit 200 is activated to receive an RF input signal comprising a single carrier. Thus, only one input stage 208A and one output stage 224A are activated, while the remaining input and output stages are disabled. As shown in FIG. 3, RF input signal 304 passes through input path 216A and then through output stage 224A which is activated by applying an activation signal to the gate terminal of NMOS device 232. The input signal 304 is then demodulated by mixer 256 which generates a baseband signal. Since only input stage 208A and output stage 224A are activated, NMOS devices 240, 248 and 252 are turned OFF by connecting their gate terminals to ground.

FIG. 4 illustrates RF circuit 200 being employed for intra-band carrier aggregation. The carriers may be intra-band contiguous or non-contiguous signals. An RF signal comprising first and second carriers 404 and 408 is received at input stage 208A. The RF signal is routed to output stage 224A by activating NMOS device 232 and also routed to output stage 224B by activating NMOS device 240. NMOS devices 248 and 252 are disabled by connecting their gate terminals to ground. The RF signal is demodulated into a first baseband signal (corresponding to carrier 404) by mixer 256 and demodulated into a second baseband signal (corresponding to carrier 408) by mixer 260.

FIG. 5 illustrates RF circuit 200 being employed for inter-band carrier aggregation. An RF signal comprising first and second carriers 504 and 508 is received at input stages 208A and 208B. The RF signal passes through input path 216A and through output stage 224A. As discussed before, NMOS device 232 is activated to enable output stage 224A. Mixer 256 demodulates the RF signal to generate baseband signal 512 corresponding to first carrier 504.

Similarly, the RF signal passes through input path 220B and through output stage 224B. NMOS device 252 is activated to enable output stage 224B. Mixer 260 demodulates the RF signal to generate baseband signal 516 corresponding to second carrier 508.

FIG. 6 illustrates a block diagram of receiver front-end 600 configured for carrier aggregation in MIMO applications. Front-end 600 includes LNAs 604A-N (only two LNAs 604A and B are shown in FIG. 6). LNA 604A includes input block 608 and two output blocks 612 and 616. Similarly, LNA 604B includes input block 620 and two output blocks 624 and 628.

In FIG. 6, output block 608 is activated for a first carrier, and output block 628 is activated for a second carrier. The first carrier is demodulated at mixer 640 and the second carrier is demodulated at mixer 644 using the same local oscillator (LO-CA1 in this case).

FIG. 7 is a flow diagram of a method according to certain disclosed embodiments. In block 704, input signals corresponding to an aggregation of carriers corresponding to intra-band or inter-band signals are received. In block 708, signal amplification of input signals are provided using a low noise amplifier having multiple separate input stages and multiple separate output stages. In block 712, carriers are routed to different output stages.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A radio frequency (RF) circuit, comprising:
a receive path configured to receive an input signal; and
a low noise amplifier having multiple separate input stages and multiple separate output stages, each input stage having multiple separate input paths, wherein each separate input path is configured to be separately activated and connected to one of the output stages, and wherein each separate output stage is configured to be separately activated and connected to a signal mixer that provides signal demodulation of the input signal employing aggregation of carriers corresponding to intra-band or inter-band signals.

2. The RF circuit as recited in claim 1, wherein only one of the multiple separate input stages is activated for processing an input signal employing aggregation of carriers corresponding to intra-band signals.

3. The RF circuit as recited in claim 1, wherein multiple separate input stages are activated for processing an input signal employing aggregation of carriers corresponding to inter-band signals, wherein the activated input stages process respective inter-band signals.

4. The RF circuit as recited in claim 1, wherein each of the separate input paths is configured to be activated to process one of the carriers in the input signal employing carrier aggregation.

5. The RF circuit as recited in claim 1, wherein each of the multiple separate input paths includes an NMOS device.

6. The RF circuit as recited in claim 5, wherein the NMOS devices are coupled in a common source arrangement, and wherein the NMOS devices are activated by biasing their respective gate terminals.

7. The RF circuit as recited in claim 1, wherein each of the multiple separate output stages includes an NMOS device coupled to a voltage source via a load.

8. The RF circuit as recited in claim 1, wherein each of the multiple separate output stages provides signal feedback isolation from the remaining output stages.

9. The RF circuit as recited in claim 1, wherein the output stages are coupled to respective mixers, wherein each mixer is configured to demodulate one of the carriers and generate a corresponding baseband signal.

10. The RF circuit as recited in claim 1, wherein at least a portion of the multiple separate output stages are activated for processing intra-band signals.

11. The RF circuit as recited in claim 1, wherein only one of the multiple separate output stages is activated for processing an intra-band signal.

12. The RF circuit as recited in claim 1, wherein the receive path and low noise amplifier are configured to process a single-ended signal, a differential signal or an IQ modulated signal.

13. A method of operating a radio frequency (RF) circuit, comprising:
receiving input signals corresponding to an aggregation of carriers corresponding to intra-band or inter-band signals; and
providing input signal amplification having multiple separate input stages and multiple separate output stages, each input stage having multiple separate input paths;
wherein each separate input path is configured to be separately activated and connected to one of the output stages, and wherein each separate output stage is configured to be separately activated and connected to a receive signal mixer that provides signal demodulation of the input signals.

14. The method as recited in claim 13, further comprising activating only one of the multiple separate input stages for processing an input signal employing aggregation of carriers corresponding to intra-band signals.

15. The method as recited in claim 13, further comprising activating multiple separate input stages for processing an input signal employing aggregation of carriers corresponding to inter-band signals, wherein the activated input stages process respective inter-band signals.

16. The method as recited in claim 13, further comprising activating each of the separate input paths to process only one of the carriers in the input signal employing carrier aggregation.

17. The method as recited in claim 13, wherein providing the input signal amplification includes providing low noise signal amplification.

18. The method as recited in claim 13, wherein each of the multiple separate output stages provides signal feedback isolation from the remaining output stages.

19. The method as recited in claim 13, further comprising activating at least a portion of the multiple separate output stages for processing intra-band signals.

20. The method as recited in claim 13, wherein receiving the input signals and providing the input signal amplification includes processing a single-ended signal, a differential signal or an IQ modulated signal.
